(19) United States
(12) Patent Application Publication
(10) Pub. No.: US 2007/0073418 A1
(43) Pub. Date: Mar. 29, 2007

(54) AOM Relay

(75) Inventor: Richard Dix Talbert JR., Blythewood, SC (US)

Correspondence Address: Richard D Talbert, 2408 Muller rd., Blythewood, SC, 29016, US

(73) Assignee: Mr. Richard Dix Talbert JR., Blythewood, SC (US)

(21) Appl. No.: 11/162,935

(22) Filed: Sep. 28, 2005

(51) Int. Cl. G05B 15/02

(52) U.S. Cl. 700/9

(57) ABSTRACT

The AOM Relay is a micro controller output-multiplying relay that will connect to any PLC or programmable controller with universal outputs. The PLC or programmable controller will send an analog voltage signal to the AOM relay. The AOM relay utilizes this analog voltage to determine which of its relays will be turned on or off. When a PLC or Programmable Controller with universal outputs needs more outputs to operate on and off devices, the AOM Relay is connected to one of the outputs of the PLC or programmable controller. Then the programming in the controller will change the output voltage that the AOM relay is connected to. The AOM Relay will utilize this voltage to determine the sequence in which the relays of the AOM will be turned on and off.

### EXAMPLE

1 volt supplied to the AOM Relay will close relay #1.

2 volts supplied to the AOM Relay will close relay #1 and relay #2.

3 volts supplied to the AOM Relay will close relay #2 and open relay #1.

This process can be continued to numerous relays from one universal output.

The AOM Relay is a micro controller output-multiplying relay that will connect to any PLC or programmable controller with universal outputs for the commercial, industrial and HVAC industry but not limited to these markets. The AOM Relay consists of a pic micro controller chip and relays used for electromechanical outputs or triacs for solid-state outputs to control field devices. The pic micro controller is programmed to use its inputs to monitor the output voltage of the PLC or programmable controller that the AOM Relay is connected to. The pic micro controller uses the voltage reference of its inputs to determine the sequence in which outputs are switched on or off.

What is claimed is:

1. AOM Relay utilizes an analog input voltage to determine which of its relays will be turned on or off.

2. The AOM Relay Can be programmed to operate its outputs in any configuration.

3. The AOM Relay will enable system designers to design complex control systems at a much lower cost by utilizing the AOM relay to multiply the outputs of a PLC or programmable controller. The cost savings will be realized by taking advantage of the universal outputs of PLC's or programmable controllers by using the voltage level of one output to control many devices.
